(19) United States
(12) Patent Application Publication
(10) Pub. No.: US 2005/0034906 A1
(43) Pub. Date: Feb. 17, 2005

(54) Power transmitting system for an electric car

(75) Inventor: Gordon Liao, Tainan Hsien (TW)

Correspondence Address: BACON & THOMAS, PLLC, 625 SLATERS LANE, FOURTH FLOOR, ALEXANDRIA, VA, 22314, US

(73) Assignee: Unique Product & Design Co., Ltd., Tainan Hsien (TW)

(21) Appl. No.: 10/638,355

(22) Filed: Aug. 12, 2003

(51) Int. Cl. B60K 1/00

(52) U.S. Cl. 180/65.6

(57) ABSTRACT

A power transmitting system for an electric car includes a brushless DC motor of low speed and high torque and a speed altering transmitting device. The speed altering transmitting device consists of two transmitting shafts and a bevel gear set with two ends respectively connected to the two transmitting shafts. The brushless DC motor has a rotor positioned around the speed altering transmitting device, and a stator positioned around the rotor. Then the two transmitting shafts are combined with two bearings respectively in two bearing bases in a front and rear cap of the brushless DC motor. Then the rotation of the brushless DC motor is directly transmitted through the speed altering transmitting device to the wheels of an electric car, without using a speed reducing gear set.

### BACKGROUND OF THE INVENTION

1. Field of the Invention

This invention relates to a power transmitting system for an electric car, particularly to one applicable to a tricycle, a four-wheeled electric car, a hybrid car or a power-assisting car and having a concise structure to facilitate maintenance and repair, and a neat appearance.

2. Description of Prior Art

Conventional electrical tricycles or four-wheeled cars are generally constituted of a chassis, a power system, a transmitting system, an electric control system, and a power battery. At present, the power transmitting system can be classified into two kinds according to the structure and an assemblage mode, and the first one consists of a high-speed, low-torque motor 10 and a speed reducing gears set 20 to be drive by the motor 10 as shown in FIG. 1. Then the rotation speed of the motor 10 is reduced properly by the speed reducing gears set 20 to be transmitted to rear wheels. But in order to let the electric car change its direction, this transmitting system (A) has a speed-altering device (not shown) additionally provided in the speed reducing gears set 20. The second kind is a hub motor transmitting system B, as shown in FIG. 2, having a low speed and high torque hub motor 40 fixed at the center of each rear wheel 30. The low speed and high torque hub motor directly drives rear wheels and an electric control system on the electric car respectively control the rotating speed of the two hub motors 40 to enable the electric car move straight or turn its direction. Those two kinds of transmitting systems respectively have the following disadvantages.

The first power transmitting system (A) using a high-speed and low-torque motor 10, as shown in FIG. 1, produces noise caused by transmission gears meshing with each other, having low transmitting efficiency and troubles involved in maintenance and repair. In addition, there are too many components positioned on the chassis, with its appearance impaired to loose the whole beauty of the car. A power transmitting system disclosed in a Taiwan patent of No. 162010 is one of these kinds.

The second power transmitting system (B) consists of a hub motor 40 respectively fixed on the hub of each rear wheel 30, and the hub motor 40 has a low speed and high torque. An electric control system is quite complicated in order to make all the hub motors 40 operate synchronously and to make the two wheels rotate with different speeds, and therefore its design may be quite difficult and its cost may be very high.

### SUMMARY OF THE INVENTION

The objective of the invention is to offer a power transmitting system for an electric car, applicable to an electric tricycle or four-wheeled car, a hybrid car, or a power-assistance car, having a concise structure to easily maintenance and repair, and a neat appearance.

### BRIEF DESCRIPTION OF DRAWINGS

This invention will be better understood by referring to the accompanying drawings, wherein:

FIG. 1 is a perspective view of a first conventional power transmitting system;

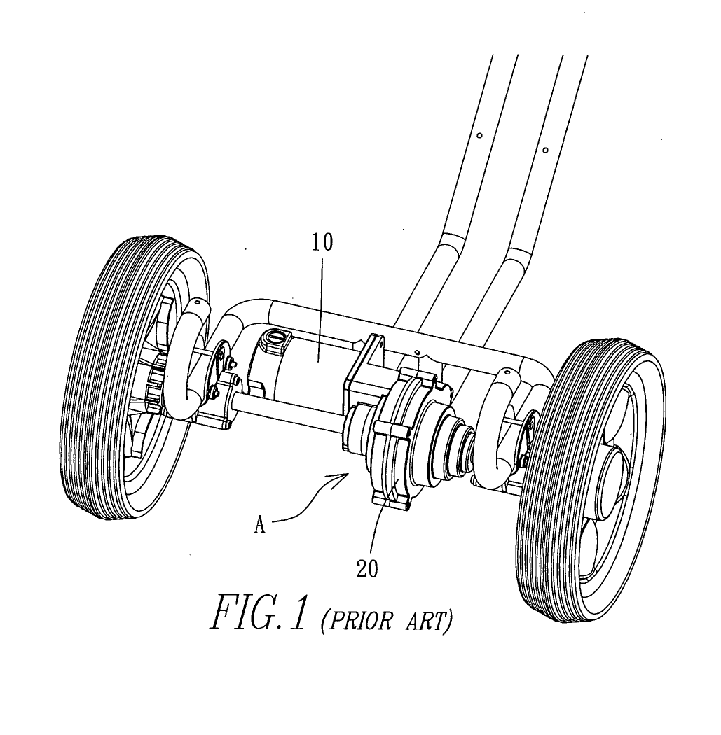

FIG. 2 is a perspective view of a second conventional power transmitting system;

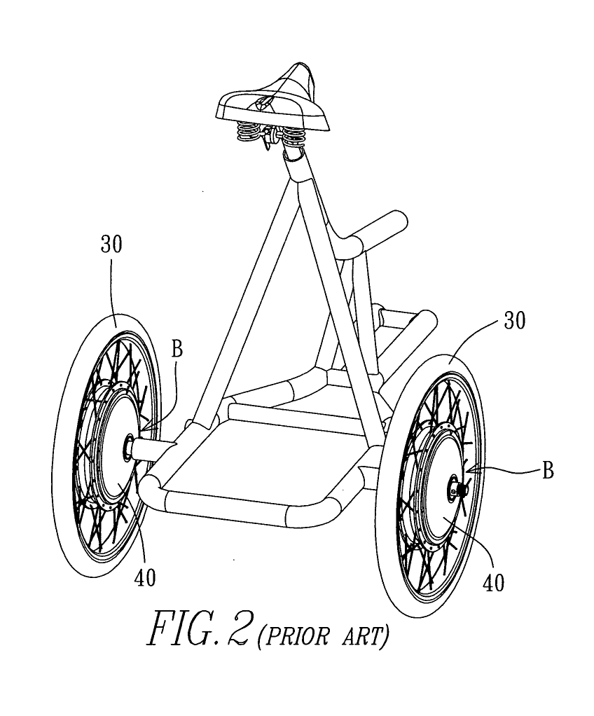

FIG. 3 is a perspective view of a first preferred embodiment of a power transmitting system in the present invention;

FIG. 4 is an exploded perspective view of a DC motor in the present invention;

FIG. 5 is an exploded perspective view of a differential gear transmitting device in the present invention;

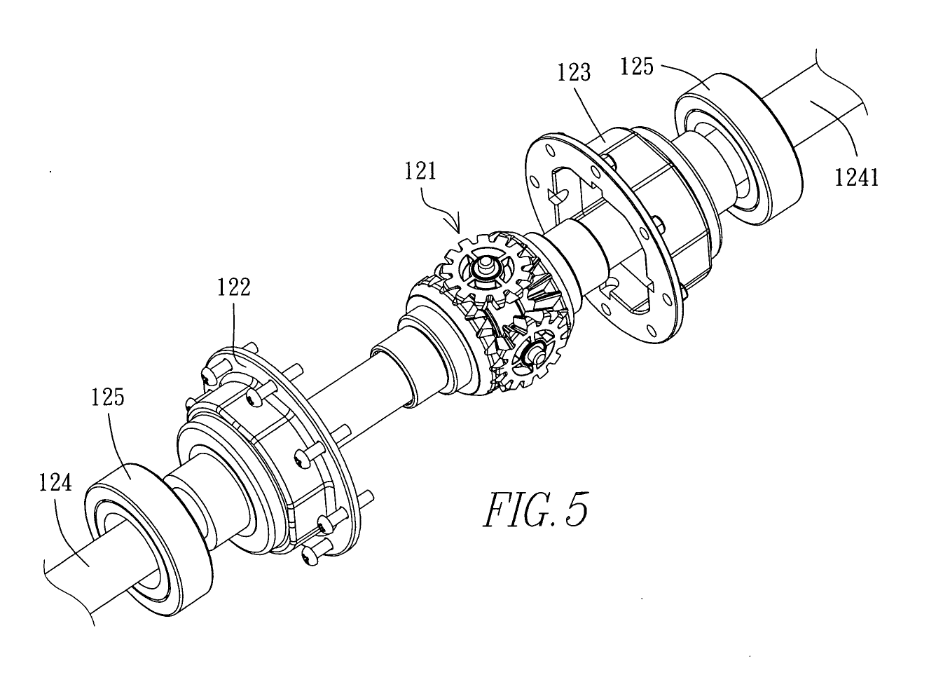

FIG. 6 is an upper view of the first preferred embodiment of the power transmitting system in the present invention;

FIG. 7 is a cross-sectional view of the line C-C in FIG. 6;

FIG. 8 is a partial enlarged view of FIG. 7;

FIG. 9 is a side view of a second preferred embodiment of a power transmitting system in operating condition in the present invention;

FIG. 10 is an upper view of the second preferred embodiment in the present invention;

FIG. 11 is a cross-sectional view of the D-D line in FIG. 10;

FIG. 12 is a partial enlarged view of FIG. 11;

FIG. 13 is an exploded perspective view of a third preferred embodiment in the present invention;

FIG. 14 is a further exploded perspective view of FIG. 13;

FIG. 15 is a cross-sectional view of the third preferred embodiment in operating condition; and,

FIG. 16 is a partial enlarged view of FIG. 15.

### BRIEF DESCRIPTION OF THE PREFERED EMBODIMENT

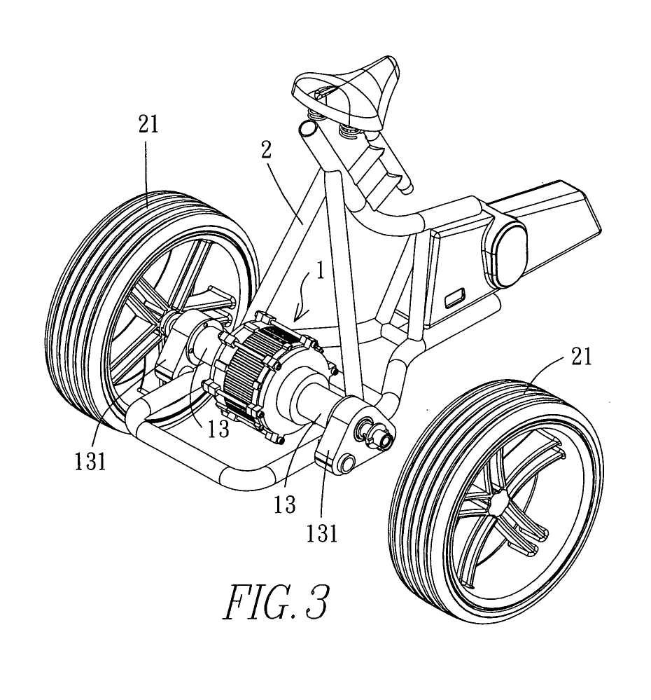

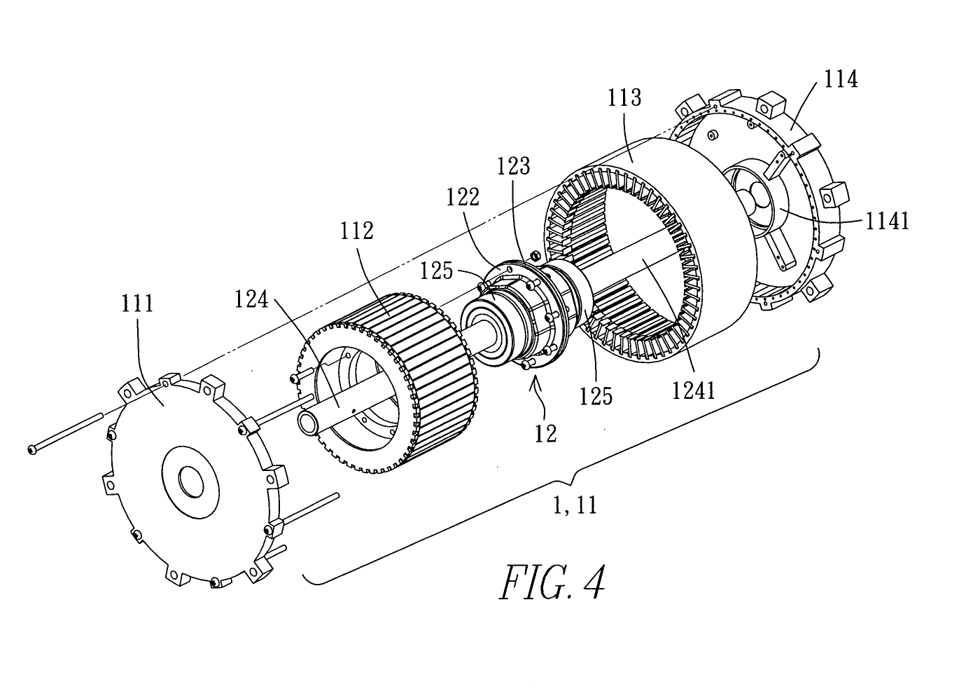

There are three preferred embodiments of a power transmitting system for an elecltric car in this invention, and a first preferred embodiment is shown in FIGS. 3 and 4, positioned between two rear wheels 21 of an electric car 2, (this embodiment is about a rear wheel driven car), including a brushless DC motor 11 with a rotor, a low speed and high torque and a differential gear transmitting device 12.

The DC motor 11 consists of a front cap 111, a rotor 212, a stator 113 and a rear cap 114.

The differential gear transmitting device 12 consists of a bevel gear set 121 , a front carp 122, a rear cap 123, a first transmitting shaft 124, a second transmitting shaft 1241 and a pair of bearings 125.

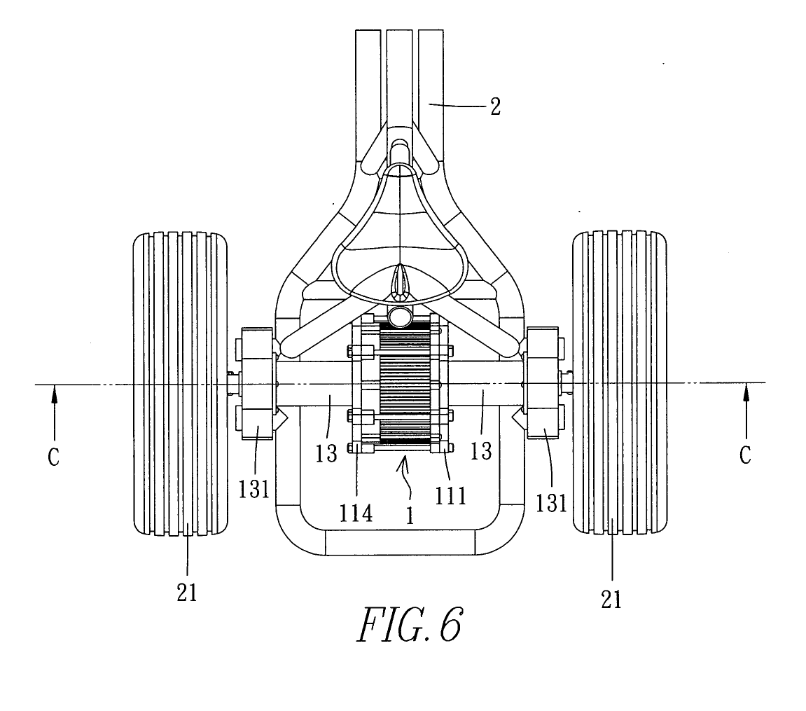

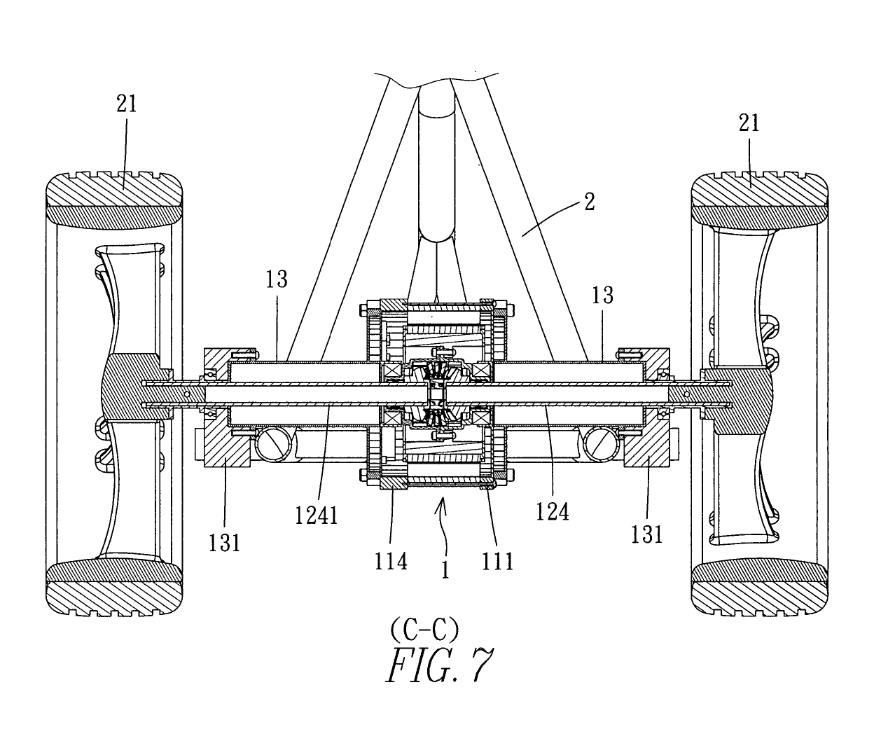

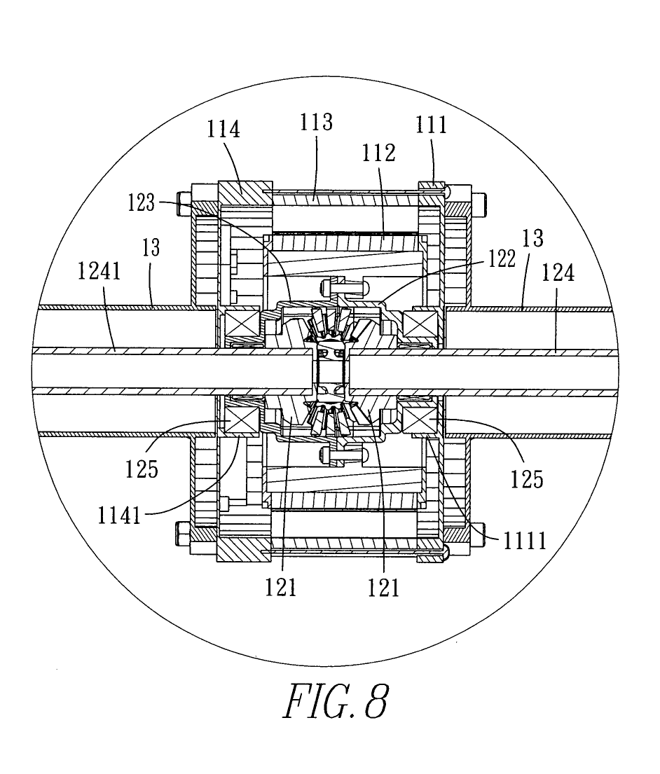

FIGS. 6, 7 and 8 show the assemblage of the power-transmitting device. The first and the second transmitting shaft 124 and 1241 are respectively connected to two ends of the bevel gear set 121, which is contained in the space between the front cap 122 and the rear cap 123. The bearings 125 are respectively fixed with the front cap 122 and the rear cap 123, finishing assemblage of the differential gear transmitting device 12. Next, the rotor 112 is combined around the differential gear transmitting device 12, with screws fixing firmly the rotor 112 with the differential gear transmitting device 12. Then the stator 113 is fixed around the rotor 112, and the bearings 125 at the two sides of the differential gear transmitting device 12 fit in bearing bases 1111, 1141 of the front carp 111 and the rear cap 114 facing the differential gear transmitting device 12, finishing assemblage of the power transmitting system 1. Then the power transmitting system 1 is positioned in an electric car as shown in FIG. 3 and 6, wherein a sleeve 13 is respectively fitted around the first transmitting shaft 124 and the second transmitting shaft 1241 to hide them without exposing out, kept immovable in a wheel axle supporter 131, thus positioning the power transmitting system 1 stably on the chassis. Finally the ends of the first and the second transmitting shaft 124 and 1241 are respectively connected to the rear wheels 21.

After assembled, when the electric car 2 is started, the DC motor 11 of the power transmitting system 11 generates rotation of high torque and low speed, with the rotor 112 directly driving the differential gear transmitting device 12 and with the first and the second transmitting shaft 124 and 1241 rotating the rear wheels 21 synchronously to move the car forward.

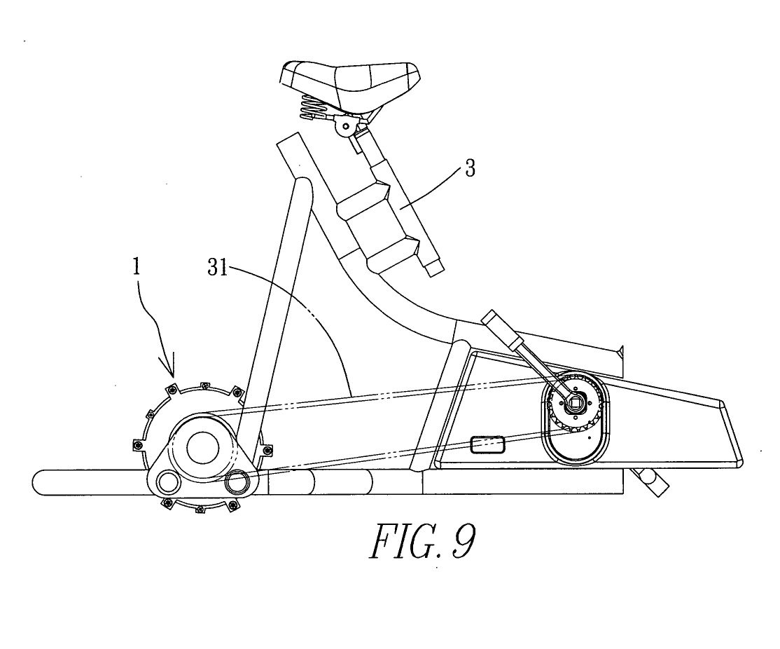

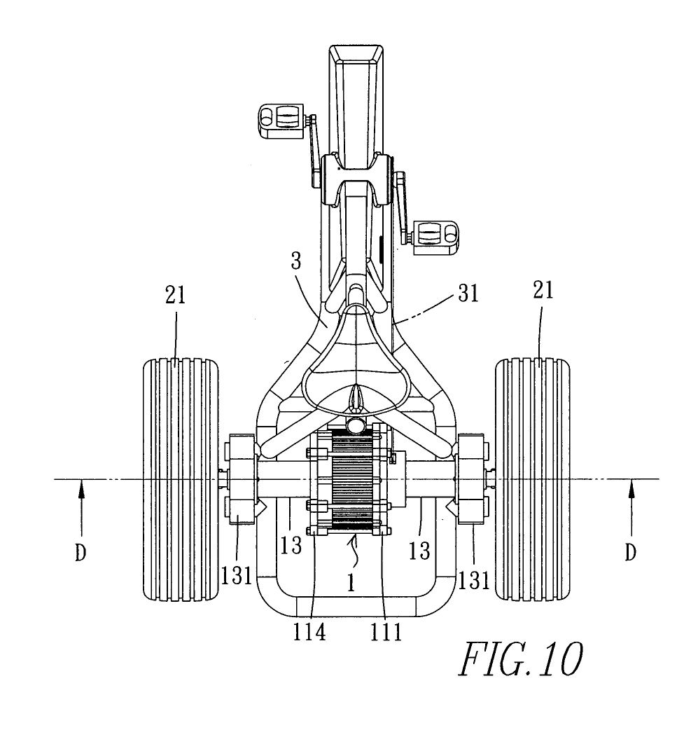

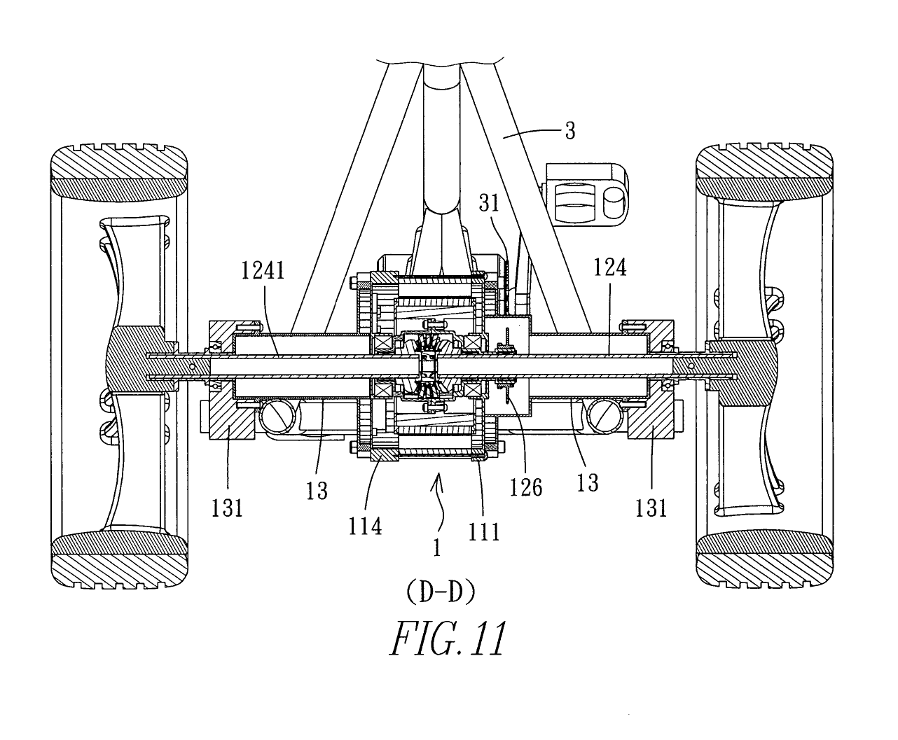

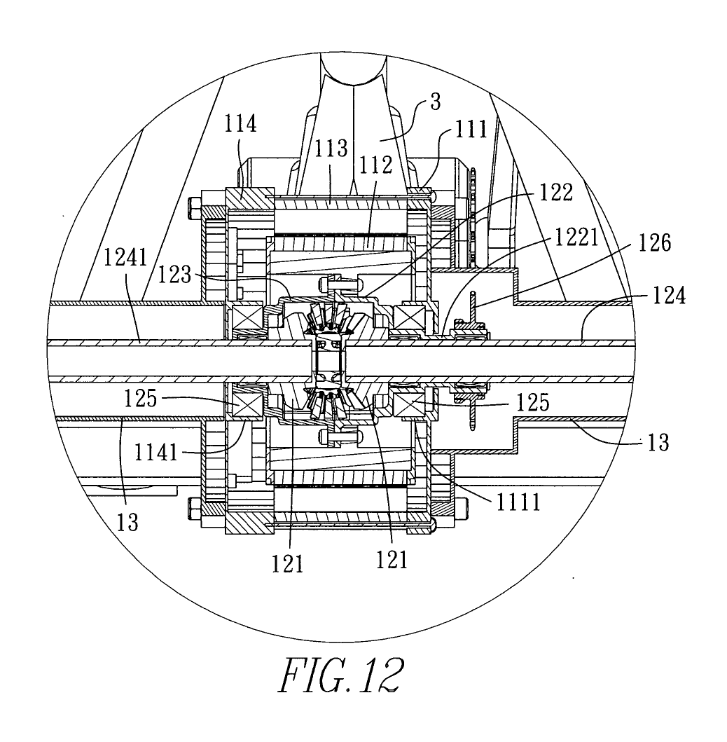

In case that the first embodiment of the invention is to be applied to a power assistance car or a hybrid car 3 (such as one with a pedal shown in FIG. 9), only adding a one-way transmitting member 126 with the differential gear transmitting device 12 can attain the purpose. Referring to FIGS. 10, 11 and 12, a sleeve 1221 is provided to extend from the front cap 122 and through the front cap 111 of the motor, and the one-way transmitting member 126 (possibly being a chain disc, a belt wheel or a bevel gear) is fixed around the sleeve 1221. Then another power source of a power assistance car 3 can be transmitted to the power transmitting system 1 by means of a chain 31 as shown in FIG. 9. This is a second preferred embodiment of the invention.

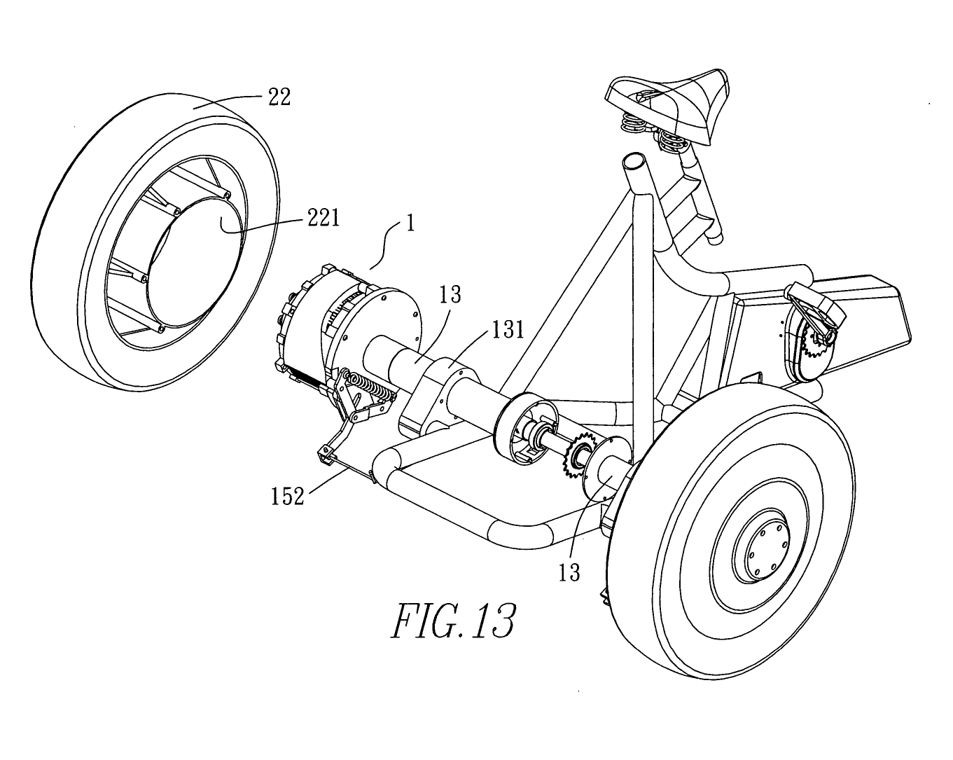

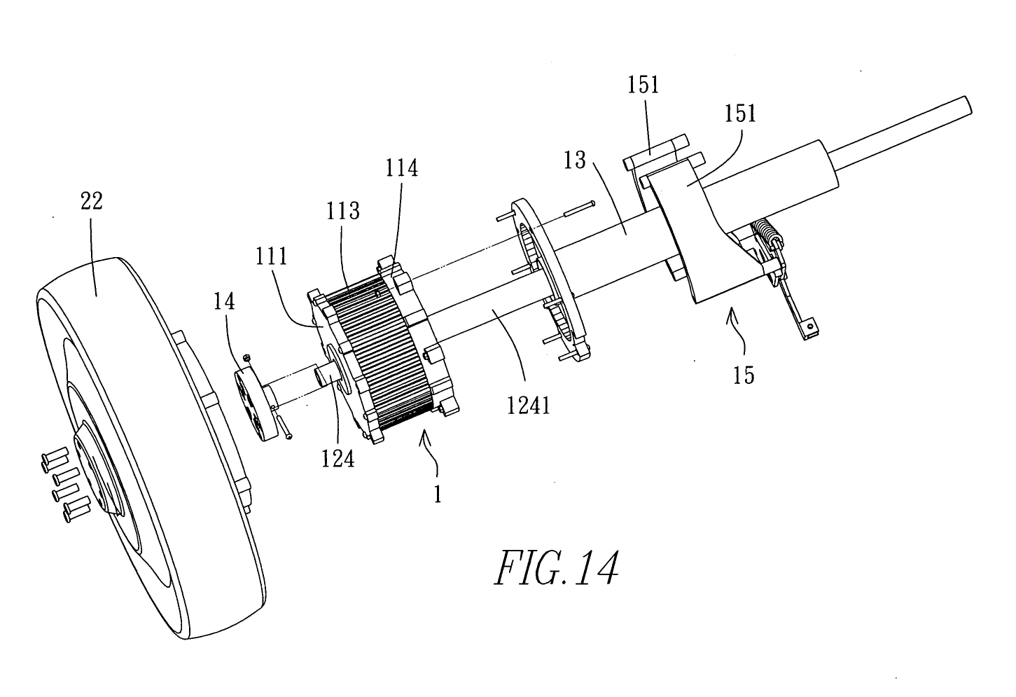

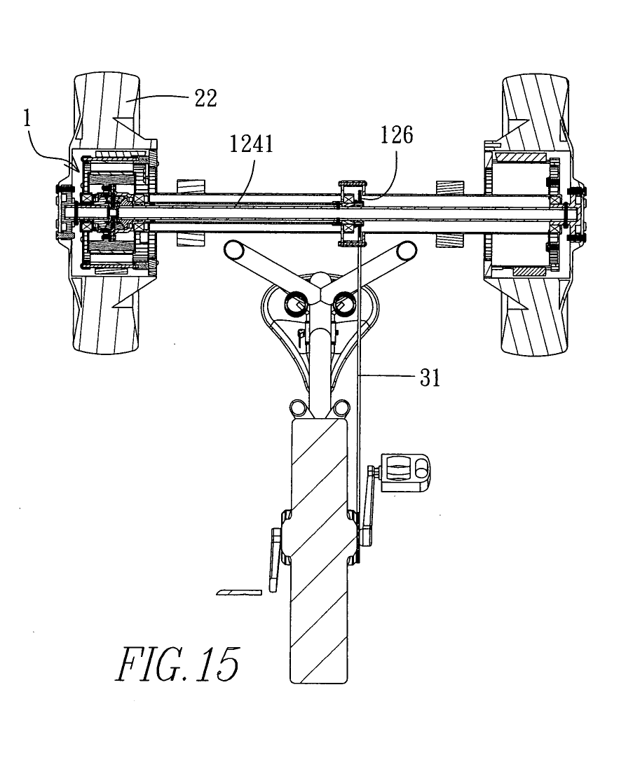

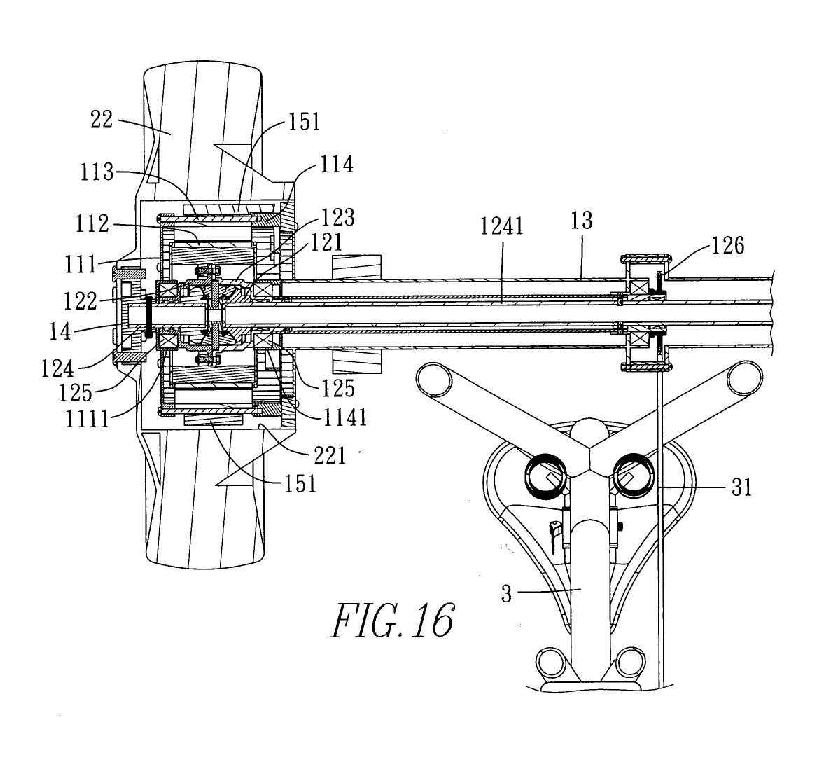

A third preferred embodiment of the invention is shown in FIGS. 13 and 14, is shaped as a column, possible to be hidden in a rear wheel body 22, including the first transmitting shaft 124 of the first embodiment, a drive block 14 fixed firmly on the outer end of the first transmitting shaft 124, and then a DC motor 11 together with the drive block 14 is positioned in the rear wheel body 22, and further, a drum brake 15 is fitted around the motor 11 in the rear wheel body 22. So if the brake wire rope 152 is pulled, the lining 151 of the drum brake 15 may friction against the inner wall of the wheel body 22 to stop the car. As shown in FIGS. 15 and 16, the wheel drive block 14 drives one of the rear wheels 22 and the second transmitting shaft 1241 drives the other rear wheel 22, not merely saving the space for the power system and the transmitting system, making the appearance of an electric car concise and beautiful.

The advantage of the present invention is that the embodiments of the invention do not produce such noise as produced by the speed reducing gears set 20 of the conventional one, enhancing efficiency of power transmission, subsequently getting rid of the problems relating to the speed reducing gears and the box for them, simplifying its structure and elevating beauty of an electric car.

While the preferred embodiments of the invention have been described above, it will be recognized and understood that various modifications may be made therein and the appended claims are intended to cover all such modifications that may fall within the spirit and scope of the invention.

1. A power transmitting system positioned between two rear wheels, said system comprising:
A brushless DC motor of low speed and high torque consisting of a front cap, a rotor, a stator and a rear cap:
A differential gear transmitting device consisting a bevel gear set, a front cap, a rear cap, a first transmitting shaft and a second transmitting shaft:
Said first and said second transmitting shaft respectively connected to two ends of said bevel gear set, said bevel gear set positioned in a space between said front cap and said rear cap, a bearing fixed respectively with said front cap and said rear cap; said rotor fixed around said differential gear transmitting device by means of screws, said stator positioned around said rotor, said bearings of said differential gear transmitting device respectively fitted in a bearing base in said front cap and said rear cap of said motor;
Said first and said second transmitting shaft of said power transmitting device respectively having the end connected to a drive wheel of said electric car, said power transmitting device producing rotation of low speed and high torque to move drive wheels of said electric car to move said car forward and turn around.

2. The power transmitting system as claimed in claim 1, wherein a sleeve is further provided to extend out of said front cap of said motor when used on a power assistance car, a one-way transmitting member fixed around said sleeve, said one-way transmitting member being a chain wheel, said chain wheel rotated by other power source of said power assistance car through a chain so that said chain wheel may combine other power source of said power assistance car with power of said power-transmitting system to rotate drive wheels of said power assistance car.

3. The power transmitting system as claimed in claim 2, wherein said one-way transmitting member is a belt wheel to combine other power source of said power assistance car with power of said power-transmitting system to rotate drive wheels of said power assistance car.

4. The power transmitting system as claimed in claim 2, wherein said one-way transmitting member is a bevel gear to combine other power source of said power assistance car with power of said power-transmitting system to rotate drive wheels of said power assistance car.

5. The power transmitting system as claimed in claim 1, wherein a sleeve is further provided to extend out of said front cap of said motor when used on a hybrid car, a one-way transmitting member fixed around said sleeve, said one-way transmitting member being a chain wheel, said chain wheel rotated by other power source of a hybrid car through a chain so that said chain wheel may combine other power source of said hybrid car with power of said power-transmitting system to rotate drive wheels of said hybrid car.

6. The power transmitting system as claimed in claim 5, wherein said one-way transmitting wheel is a belt wheel to combine other power source of said hybrid car with power of said power-transmitting system to rotate drive wheels of said hybrid car.

7. The power transmitting system as claimed in claim 5 said one-way transmitting wheel is a bevel gear to combine other power source of said hybrid car with power of said power-transmitting system to rotate drive wheels of said hybrid car.

8. The power transmitting system for an electric car as claimed in claim 1, wherein a drive block is further fixed at an outer side of said first transmitting shaft, said drive block together with said power transmitting system are positioned in said drive wheel, with said drive block fixed firmly together with said drive wheel of said electric car, letting said brushless DC motor rotate said drive block to rotate said drive wheel of said electric car, with said power transmitting system hidden completely in said drive wheels.
